(19) United States
(12) Patent Application Publication
(10) Pub. No.: US 2025/0238503 A1
(43) Pub. Date: Jul. 24, 2025

(54) MALICIOUS CODE DETECTION BASED ON CODE PROFILES GENERATED BY EXTERNAL AGENTS

(71) Applicant: Akeana, Inc., Santa Clara, CA (US)

(72) Inventor: Rabin Sugumar, Sunnyvale, CA (US)

(73) Assignee: Akeana, Inc., Santa Clara, CA (US)

(21) Appl. No.: 19/072,114

(22) Filed: Mar. 6, 2025

Related U.S. Application Data
(63) Continuation-in-part of application No. 18/389,995, filed on Dec. 20, 2023.
(60) Provisional application No. 63/745,432, filed on Jan. 15, 2025.
(60) Provisional application No. 63/735,937, filed on Dec. 19, 2024.
(60) Provisional application No. 63/730,997, filed on Dec. 12, 2024.
(60) Provisional application No. 63/719,841, filed on Nov. 13, 2024.
(60) Provisional application No. 63/714,529, filed on Oct. 31, 2024.
(60) Provisional application No. 63/702,192, filed on Oct. 2, 2024.
(60) Provisional application No. 63/699,245, filed on Sep. 26, 2024.
(60) Provisional application No. 63/691,351, filed on Sep. 6, 2024.
(60) Provisional application No. 63/690,822, filed on Sep. 5, 2024.
(60) Provisional application No. 63/687,795, filed on Aug. 28, 2024.
(60) Provisional application No. 63/679,685, filed on Aug. 6, 2024.
(60) Provisional application No. 63/679,192, filed on Aug. 5, 2024.
(60) Provisional application No. 63/653,402, filed on May 30, 2024.
(60) Provisional application No. 63/640,921, filed on May 1, 2024.
(60) Provisional application No. 63/641,045, filed on May 1, 2024.
(60) Provisional application No. 63/570,281, filed on Mar. 27, 2024.
(60) Provisional application No. 63/564,529, filed on Mar. 13, 2024.
(60) Provisional application No. 63/563,492, filed on Mar. 11, 2024.
(60) Provisional application No. 63/563,102, filed on Mar. 8, 2024.
(60) Provisional application No. 63/605,620, filed on Dec. 4, 2023.
(60) Provisional application No. 63/602,514, filed on Nov. 24, 2023.
(60) Provisional application No. 63/547,574, filed on Nov. 7, 2023.
(60) Provisional application No. 63/547,404, filed on Nov. 6, 2023.
(60) Provisional application No. 63/546,769, filed on Nov. 1, 2023.
(60) Provisional application No. 63/545,961, filed on Oct. 27, 2023.
(60) Provisional application No. 63/542,797, filed on Oct. 6, 2023.
(60) Provisional application No. 63/526,009, filed on Jul. 11, 2023.
(60) Provisional application No. 63/521,365, filed on Jun. 16, 2023.
(60) Provisional application No. 63/471,283, filed on Jun. 6, 2023.
(60) Provisional application No. 63/467,335, filed on May 18, 2023.
(60) Provisional application No. 63/463,371, filed on May 2, 2023.
(60) Provisional application No. 63/462,542, filed on Apr. 28, 2023.
(60) Provisional application No. 63/444,619, filed on Feb. 10, 2023.
(60) Provisional application No. 63/439,761, filed on Jan. 18, 2023.
(60) Provisional application No. 63/436,133, filed on Dec. 30, 2022.
(60) Provisional application No. 63/436,144, filed on Dec. 30, 2022.
(60) Provisional application No. 63/435,831, filed on Dec. 29, 2022.
(60) Provisional application No. 63/435,343, filed on Dec. 27, 2022.
(60) Provisional application No. 63/434,104, filed on Dec. 21, 2022.
(60) Provisional application No. 63/764,198, filed on Feb. 27, 2025.
(60) Provisional application No. 63/765,094, filed on Feb. 28, 2025.

(51) Int. Cl. G06F 21/54; G06F 21/55; G06F 21/56

(52) U.S. Cl. CPC G06F 21/54; G06F 21/554; G06F 21/564

(57) ABSTRACT

Disclosed embodiments provide techniques for malicious code detection in a processor core. A system-on-a-chip (SoC) is accessed. The SoC includes one or more processor cores. Each processor core is coupled to one or more external profiling agents (EPAs) on the SoC. An EPA configures a performance counter in a processor core within the SoC. The configuring is based on an offset value. The processor core updates the performance counter that was configured, based on a processor core event. A program state is saved to a performance counter storage area, based on a performance counter event. The program state that is saved corresponds to code being executed on the processor core. The program state is read from the performance counter storage area by the EPA. The EPA interprets the program state that was read, which identifies a malicious program running on the processor core.

### RELATED APPLICATIONS

This application claims the benefit of U.S. provisional patent application “Malicious Code Detection Based On Code Profiles Generated By External Agents” Ser. No. 63/563, 102, filed Mar. 8, 2024, “Processor Error Detection With Assertion Registers” Ser. No. 63/563,492, filed Mar. 11, 2024, “Starvation Avoidance In An Out-Of-Order Processor” Ser. No. 63/564,529, filed Mar. 13, 2024, “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679, 192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702, 192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764, 198, filed Feb. 27, 2025, and “Transformed Activation Function With ISA Extension” Ser. No. 63/765,094, filed Feb. 28, 2025.

This application is also a continuation-in-part of U.S. patent application “Processor Performance Profiling Using Agents” Ser. No. 18/389,995, filed Dec. 20, 2023, which claims the benefit of U.S. provisional patent applications “Processor Performance Profiling Using Agents” Ser. No. 63/434, 104, filed Dec. 21, 2022, “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436, 133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to code detection and more particularly to malicious code detection based on code profiles generated by external agents.

### BACKGROUND

Malice can be defined as desiring or intending to do harm or commit an unlawful act without justification or excuse. This does not mean that acts of malice are without cause or purpose. Many individuals and groups have perpetrated malicious actions with specific goals in mind. Hate groups have used threats, intimidation, acts of violence, and murder to drive away or eliminate other groups of people. In the U.S., the Ku Klux Klan was formed in the aftermath of the Civil War in order to restore white supremacy through violence and intimidation against African Americans and those who supported them. Lynchings, beatings, burning crosses, and other acts of violence were perpetrated throughout the South with long-ranging impact, even to this day. The Nazi Party of Germany in the 1930s actively promoted anti-Semitism and white supremacy, eventually leading to the extermination of millions of Jews and other minorities throughout Europe. The Animal Liberation Front, formed in the 1970s, has used bombings, arson, and other acts of violence in an attempt to promote and defend animal rights.

Acts of malice have been crafted to advocate for political causes. Wars and other regional conflicts are often conducted in many parts of the world to gain control of governments and territories. These fights often lack any sense of fairness or honor. They can be savage, brutal, and can easily spread to include non-combatants, including children. During the Punic Wars, Rome sought to completely destroy the city of Carthage, eventually capturing the city, razing it, and selling the inhabitants as slaves. Genghis Khan led the Mongol Empire to annihilate various states and people groups. Whole cities were destroyed, and populations were massacred in order to instill fear and promote submission to the empire. In the early 1900s, German colonial forces nearly wiped out the local Herero and Namaqua populations. Nearly a quarter of the population in Cambodia was murdered by the Khmer Rouge under the leadership of Pol Pot in order to establish an agrarian socialist society. In the U.S., several wars have been fought against native Americans since the arrival of the European settlers in the 1600s. The result has been a series of broken treaties, significant loss of life, and the displacement of tribes across the country, as well as the establishment of the United States as the supreme government authority.

Acts of malice are not limited to a particular sphere of society. For example, the advent and proliferation of personal and business computers connected via the Internet has enabled significant business and personal improvements. But it has also led to increases in malicious behavior. These can include spying, stealing information, encrypting information against a user's wishes, disabling critical public infrastructure, and so on. In 1988, a Cornell graduate student released a worm from a computer at MIT. The worm caused denial-of-service for nearly 10% of UNIX systems across the country, damaging systems at Harvard, Stanford, John Hopkins, NASA, and military installations. Eleven years later, a teenage hacker accessed computers at NASA's Marshall Space Center, stealing software and causing a 21-day shutdown of NASA's computer systems. That same year, the Melissa virus caused widespread damage to computer systems and networks across the U.S. and Europe. Such attacks continue to this day. As long as personal and political goals are at odds throughout the world, it is likely that malicious activity will continue.

### SUMMARY

Processors of various types enable a wide range of devices to perform essential, useful, and desirable tasks and applications. However, these same devices can be used for malicious purposes. In fact, malicious attacks on computer systems have only increased as personal computers and online data have become ubiquitous and highly valuable. These attacks can include a ransomware attack, where data is encrypted; an exfiltration attack, where data is compressed and sent to a remote server; a locking attack, where boot files are password locked; a physical attack, where voltage, clocks, etc., are altered; and so on. Software packages have been designed to detect malicious code; however, hardware monitoring can be an effective technique for catching and removing potential malicious threats. Monitoring processor behavior can yield important insights into whether malicious code is running and can alert a system or user to take action to thwart an attack.

Disclosed embodiments provide techniques for malicious code detection in a processor core. A system-on-a-chip (SoC) is accessed. The SoC includes one or more processor cores. Each processor core is coupled to one or more external profiling agents (EPAs) on the SoC. An EPA configures a performance counter in a processor core within the SoC. The configuring is based on an offset value. The processor core updates the performance counter that was configured, based on a processor core event. A program state is saved to a performance counter storage area, based on a performance counter event. The program state that is saved corresponds to code being executed on the processor core. The program state is read from the performance counter storage area by the EPA. The EPA interprets the program state that was read which identifies a malicious program running on the processor core.

A processor-implemented method for malicious code detection is disclosed comprising: accessing a system-on-a-chip (SoC), wherein the SoC includes one or more processor cores, wherein each processor core within the one or more processor cores is coupled to one or more external profiling agents (EPAs) on the SoC; configuring, by an EPA within the one or more EPAs, a performance counter in a processor core within the one or more processor cores, wherein the configuring is based on an offset value; updating, by the processor core, the performance counter that was configured, wherein the updating is based on a processor core event; saving a program state to a performance counter storage area, wherein the saving is based on a performance counter event, wherein the program state that is saved corresponds to code being executed on the processor core; reading the program state, from the performance counter storage area, by the EPA; and interpreting, by the EPA, the program state that was read, wherein the interpreting identifies a malicious program running on the processor core.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for malicious code detection based on code profiles generated by an external profiling agent.

FIG. 2 is a flow diagram for comparing code profiles.

FIG. 3 is a block diagram for code profiling.

FIG. 4 is a block diagram illustrating a multicore processor.

FIG. 5 is a block diagram for a pipeline.

FIG. 6 is an example illustrating malicious code detection.

FIG. 7 is an example of comparing profiles.

FIG. 8 is a system diagram for malicious code detection based on code profiles generated by an external profiling agent.

### DETAILED DESCRIPTION

Techniques for malicious code detection based on external profiling agents are disclosed. A processor, such as a standalone processor, a processor chip, a processor core, a processor within a system-on-a-chip (SoC), and so on, can be used to perform various data processing tasks. These data processing tasks can comprise applications used for business, research, personal, government, or other purposes. Under normal circumstances, the processor executes code according to a known profile. The profile, code profile, or performance profile can represent computational resource usage as code is executing on the processor. The code profile can show changes in resource usage within one or more processors within an SoC over time as the code executes. Each time the code is executed, the code profile is substantially similar. This substantial similarity can be monitored for changes in the code profile. Some changes in the code profile can be expected based on which codes are executing in the processor core at a given time, interrupts which can occur asynchronously, operating system activity, and so on. The changes, when sufficiently different, can indicate anomalous behavior of the code. The anomalous behavior can be indicative of malicious code. Thus, by identifying anomalous code profile behavior, malicious code can be detected, identified, and addressed. The profile can include a plurality of measurements including memory accesses, page faults, cache usage, instruction frequency, fetch locations, branch statistics, or other measures. The profile can include an identifier of the processor which can include address space identifiers, virtual machine identifiers, processor IDs, and so on. Disclosed techniques provide a means for detecting the malicious code with external agents on an SoC. This can allow the system or the user to take action to remove the malicious code before the code is able to cause damage.

An SoC is accessed. The SoC can include one or more processor cores. Each processor core is coupled to one or more external profiling agents (EPAs) on the SoC. The EPA can run on separate logic on the SoC. An EPA can perform a variety of tasks, such as monitoring and profiling tasks. An EPA can monitor the executing of code and the processor state as the code is executing on the processor. The EPA can monitor one or more program states, generate a code profile from the program states, and so on. The program states can be associated with a particular code running in a processor, processor core, multicore processor, etc. The EPA allows the processor core to execute code, to perform operating system tasks, and so on, without having to spend resources on tracking performance or generating a code profile to be used to detect the malicious software. The processor core is configured by the EPA. The configuring includes setting a performance counter within the processor core. The configuring is based on an offset value. The offset value can comprise a distance from a performance counter overflow value. Alternatively, the offset value can comprise a distance from a performance counter underflow value. The processor core updates the performance counter that was configured. The updating is based on a processor core event. The processor core event can include a page fault, a memory access, a branch misprediction, and so on. A program state can be saved to a performance counter storage area, based on a performance counter event. The performance counter event can be an overflow, and underflow, an increment, a decrement, and so on. The program state corresponds to code that is executed on the processor core. The EPA reads the program state from the performance counter storage area. The EPA then interprets the program state which includes identifying a malicious program running on the processor core. The EPA can reset the performance counter and the above steps can be periodically repeated, which can result in generating a code profile over time. The EPA can compare the code profile to a known profile of one or more malicious programs.

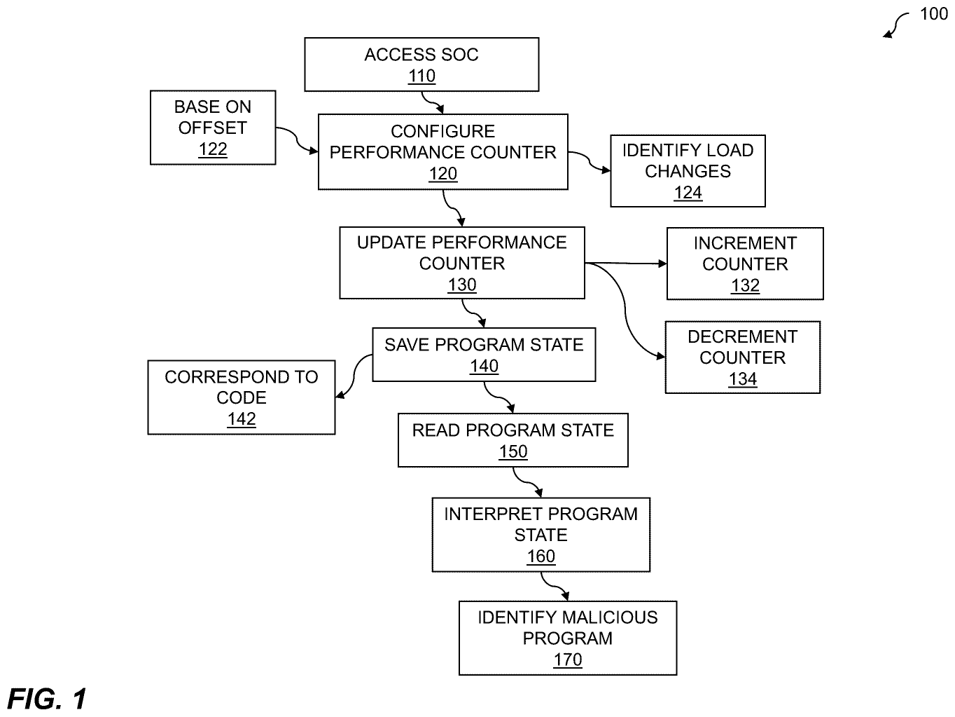

FIG. 1 is a flow diagram for malicious code detection based on code profiles generated by an external profiling agent (EPA). An EPA can be used to monitor one or more program states, to generate a code profile based on one or more program states, and so on. The program states can be associated with a particular code running on a processor such as a processor core. The particular code can be executed on multiple processors. A processor can include a multicore processor such as a RISC-V™ processor. The processor cores can include homogeneous processor cores or heterogeneous processor cores. The cores that are included can have substantially similar capabilities or substantially different capabilities. The one or more processor cores can include further elements. The further elements can include one or more of physical memory protection (PMP) elements, memory management (MMU) elements, level 1 (L1) caches such as instruction caches and data caches, level 2 (L2) caches, and the like. A multicore processor can further include a level 3 (L3) cache, test and debug support such as joint test action group (JTAG) elements, a platform level interrupt controller (PLIC), an advanced core local interrupter (ACLINT), and so on.

The flow 100 includes accessing a system-on-a-chip (SoC) 110. The SoC can include one or more processor cores. The SoC can include an integrated circuit or chip, a programmable or configurable integrated circuit such as an FPGA or ASIC, etc. In embodiments, the processor core can include RISC-V™ processor core. Each processor core within the one or more processor cores can be coupled to one or more external profiling agents (EPAs) on the SoC. One or more EPAs can operate independently of the processor core, thereby freeing the processor core to perform its code execution tasks. The EPA can generate performance profiles which can more accurately reflect a code execution profile. A software agent such as an EPA can perform a variety of tasks, such as monitoring and profiling tasks. An external profiling agent can monitor the executing of code, and the processor state as the code is executing on the processor. The external profiling agent can monitor one or more program states, generate a performance profile from the program states, and so on.

The profiling agents can interpret a program state to identify a malicious program running on the processor core. The processor core can further include various components that supplement or enhance the operation of the processor core. The processor core includes a performance counter, a performance counter storage area, and a performance counter control register. The performance counter, the performance counter storage area, and the performance counter control register can enable the processor to read a program state that was saved based on a performance counter event such as a counter overflow or a counter underflow. The counter, counter storage area, and counter control register further enable the EPA to generate profiles associated with the execution of the program based on the processor state. The processor core includes a performance monitoring interface. The performance monitoring interface can enable the processor core to interact with an external profiling agent. The performance monitoring interface enables reading of a state such as a program state by an external profiling agent. The external profiling agent can generate the performance profile associated with program execution, thereby freeing the processor core to execute operations associated with a program unimpeded by determining the program profile. Further, the external agent can perform program profiling substantially continuously. Each processor of the one or more processor cores has access to memory such as a common memory. The common memory can include on-chip memory, off-chip memory, etc.

The flow 100 includes configuring 120, by an EPA within the one or more EPAs, a performance counter in a processor core within the one or more processor cores. The configuring can include setting the performance counter, resetting the performance counter, and so on. The configuring can be accomplished prior to execution of a particular code, while the particular code is executing, and so on. The configuring can be accomplished using a performance monitor interface, memory mapping, and so on. The configuring can be based on an event within the processor core which can include particular code starting, running, etc. on the processor core; human direction provided by an authorized user such as s system administrator; a page fault, exception, interrupt, etc.; physical events such as a voltage spike or droop above or below a respective threshold; clock errors; excessive heat generation; and so on.

In the flow 100, the configuring is based on an offset value 122. The offset value can include a count, where the count can be associated with a count or tally of a number of processor core events. In embodiments, the processor core event can include a page fault. The count can include a count up based on incrementing the offset value, or a count down based on decrementing the offset value. In a usage example, a performance counter can be configured with an offset value set to −100 indicating that the counter will be decremented. The value loaded into the performance counter would be 0−(−100)=100. As a processor event such as a page fault occurs, the performance counter can be decremented. When the number of processor events equal to the offset has occurred, the performance counter can underflow. The underflow event indicates that the offset number of processor events have occurred. A number of processor events, such as page faults described above, occurring over a time period, can be included in a known code profile of the code. Later, when executing code is run, the same processor events can be monitored and compared to the known profile. A substantially similar result, such as a number of page faults significantly over a known code profile, can indicate an anomaly in processor execution. The anomaly can be further investigated to ensure that no malicious code is running on the processor, causing the profile to deviate from the known profile.

In embodiments, the configuring can include a performance counter control register. The performance counter control register can control incrementing or decrementing the control register, setting and resetting the control register, etc. In embodiments, the performance counter control register can include settings for the processor core event, whether profiling is enabled, and what a sampling period comprises. In embodiments, the performance counter can include an activity counter. The activity counter can count a number of events such as processor events. Processor events can include memory access events, exceptions, and so on. In the flow 100, the activity counter can identify load changes 124 within the processor core. Load changes can include changes to CPU usage percentage, numbers of threads, GPU usage percentage, memory accesses, cache usage, usage of issue queues, etc.

The flow 100 includes updating, by the processor core, the performance counter 130 that was configured, wherein the updating is based on a processor core event. The updating can include various operations associated with the performance counter. In the flow 100, the updating can include incrementing 132, by the processor core, the performance counter, wherein the performance counter event is an overflow, and wherein the offset value comprises a distance from a performance counter overflow value. The increment can include a value such as 1, 2, and so on. The offset distance can include the number of updates that can be performed on the performance counter. In the flow 100, the updating can comprise decrementing 134, by the processor core, the performance counter, wherein the performance counter event is an underflow, and wherein the offset value comprises a distance from a performance counter underflow value. The decrement can include a value such as −1, −2, and the like. The increment and the decrement can include substantially similar values. In embodiments, the processor event comprises a page fault. In other embodiments, the processor event comprises a system call. In further embodiments, the processor event comprises a use of timers. The processor event can include any type of event taking place within the processor core. In embodiments, the performance counter comprises an activity counter.

The flow 100 includes saving a program state 140 to a performance counter storage area. The performance storage area can include an area of storage dedicated to storing a program state, a register file, a cache, shared storage, and so on. The saving is based on a performance counter event. The performance counter event can include a counter overflow, a counter underflow, etc. In embodiments, the program state that is saved comprises a value from the performance counter. For example, the program state can comprise the number of page faults taken by the processor, the number of times a timer was used, the number of system calls made, and so on. In the flow 100, the program state that is saved corresponds to code 142 being executed on the processor core. The program state can include a profile associated with a code, runtime statistics, and the like. The program state that is saved can be associated with a time period of execution within the code. In embodiments, the program state can include execution identification values. Execution identification values can include a code, a label, a number, a hash, and so on. In embodiments, the program execution identification values can include an address space identifier (ASID). In other embodiments, the execution identification values can include a virtual machine identifier (VMID). The flow 100 includes reading the program state 150, from the performance counter storage area, by the EPA. The reading the program state can include loading the program state into one or more processor cores with the SoC. The reading the program state can be processed, analyzed, and so on.

The flow 100 includes interpreting, by the EPA, the program state 160 that was read. The saved program states can be interpreted to provide data, information, and so on associated with the program. The saved program states can be analyzed, counted, compared, and so on. A large amount of data associated with numerous performance counters can be saved in the program state. In embodiments, the interpreting can be based on machine learning. A machine learning model, such as a neural network, convolutional neural network, etc., can be used to parse a large amount of data, look for patterns, and compare to typical patterns associated with malicious code. The associating can be based on data from a single performance counter or a plurality of performance counters. The interpreting can include evaluating any number of events that were counted by the performance counter and saved as part (or all) of the program state. In embodiments, the interpreting is based on the number of system calls performed by the code running on the processor core. Intensive use of system calls can be an indication that a malicious program is attempting to gain information associated with a higher privilege level. In other embodiments, the interpreting is based on the number of times that timers were used by the program. The use of timers can be an indication that a malicious program is attempting to gain information about how long certain processor core events are taking. In further embodiments, the interpreting is based on the number of page faults that occurred in the processor core. An unusually high number of page faults can be an indication that a malicious program is attempting to gather information, overwrite memory structures, or otherwise interrupt normal operations of the processor core. Any number of other events can be counted and saved as part (or all) of the program state to aid in the process of determining the presence of malicious code running on the processor core. In embodiments, the performance counter comprises an activity counter. In further embodiments, the activity counter identifies load changes within the processor core.

In the flow 100, the interpreting identifies a malicious program 170 running on the processor core. The activity counter can be used to detect malicious activity. In embodiments, the interpreting includes comparing the code profile to a known profile of code being executed on the processor core. The known profile of the code being executed can be uploaded by a user, downloaded from a repository such as a library of known profiles, and so on. One or more known “good” code profiles can be generated by gathering data based on a plurality of performance counters when the processor is known to be running “safe” (e.g., non-malicious) code. Likewise, one or more known “malicious” code profiles can be generated by gathering data based on a plurality of performance counters when the processor is known to be running malicious code. Known good and/or malicious code profiles can be assembled with the information from the performance counters such that a typical number of processor events can be associated with one or more programs, processes, etc. that can run on the processor core.

The malicious program can be identified by comparing the profile to one or more known good or malicious profiles associated with known malicious programs. Profiles can be uploaded by a user, downloaded from a repository or library, etc. The interpreting can be based on a substantially same or different number of processor events that were captured by the performance counters.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

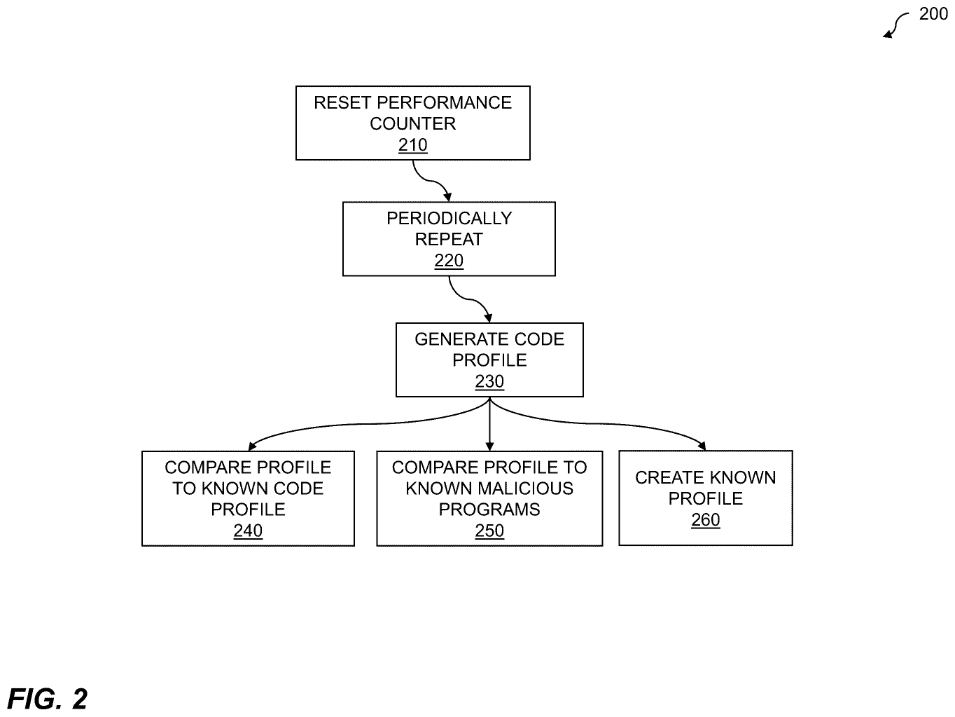

FIG. 2 is a flow diagram for comparing code profiles. Code profiles can be generated, which can aid in the detection and/or removal of malicious code running on a processor, system, in memory, etc. Disclosed techniques can compare a known “good” code profile to a collected code profile in order to make determinations as to whether the code profile is representative of anomalous behavior, which can indicate the presence of malicious code. A system-on-a-chip (SoC) is accessed. The SoC includes one or more processor cores. Each processor core is coupled to one or more external profiling agents (EPAs) on the SoC. An EPA configures a performance counter in a processor core within the SoC. The configuring is based on an offset value. The processor core updates the performance counter that was configured, based on a processor core event. A program state is saved to a performance counter storage area, based on a performance counter event. The program state that is saved corresponds to code being executed on the processor core. The program state is read from the performance counter storage area by the EPA. The EPA interprets the program state that was read which identifies a malicious program running on the processor core.

The flow 200 includes resetting, by the EPA, the performance counter 210. Recall that one or more performance counters can be configured by the EPA and updated by a processor core. Recall also that a program state, which is based on a performance counter event, can be saved to a performance counter storage area. Once the program state is saved, the one or more performance counters can be reset and can be reused to capture additional program state. In a usage example, a performance counter that measures a number of page faults can be incremented until a counter overflow is detected. The overflow, number of page faults, the time associated with the number of page faults, etc. can be recorded by the EPA as part of the program state. The EPA can then reset or reconfigure the performance counter to save additional details about the program state. The additional details can again be based on page faults or another program state parameter. The resetting can occur due to an SoC reset, a program reset, human activity, and so on. The resetting can result from interpreting the program state. When an overflow event is detected, the resetting can include a maximum value less the offset. Similarly, when an underflow event is detected, the performance counter can be reset to a minimum value plus the offset.

In the flow 200, the configuring, the updating, the saving, and the resetting can be periodically repeated 220. One or more of the steps associated with malicious code detection can be repeated, omitted, reordered, and so on. The periodic repetition can be controlled by a processor core within the SoC, by a controller associated with the processor core, and so on. The periodic repetition can be based on program execution, where the repetition occurs based on one or more performance counter events such as a counter overflow or counter underflow. The periodic repetition can be based on a timer, performance counter, human intervention, a process running on the processor, etc. The configuring, the updating, the saving, and the resetting can occur every time a program or process is executed. The configuring, the updating, the saving, and the resetting can also be performed for an operating system executing on the SoC.

The flow 200 includes generating a code profile 230, based on the updating, the saving, the reading, and the resetting. The code profile can be generated for a newly developed program, a common program, a regularly used program, a loop, a subroutine, and so on. The generating can be based on numerous performance counters tracking numerous states and/or statistics within the processor core. Thus, it is possible to generate a large amount of data to understand the processor state while executing code. The profile that is generated can be saved to a repository of code profiles. As described earlier, the generated code profile can be interpreted. The interpreting can include searching for erroneous, anomalous, or suspicious program execution. A variety of techniques can be used for the interpreting. In embodiments, the interpreting comprises comparing the code profile to a known profile 240 of the code being executed on the processor core. A code profile that is substantially similar to that of a known “good” code profile (e.g., a code profile without malicious code), can indicate that malicious code is not present in the system, processor, cache, etc. The known profile can be provided by the user, obtained from a repository, etc. In embodiments, the comparing includes machine learning. In embodiments, the interpreting comprises comparing the code profile to a known profile of one or more malicious programs 250. A code profile that is substantially similar to that of code running with a malicious program can indicate that malicious software has infected the system, processor, cache, etc. The known profile of one or more malicious programs can also be provided by the user, obtained from a repository, collected from a third party, etc.

In embodiments, the comparing includes machine learning. Evaluating and comparing code profiles can include a large amount of data, especially if many performance counters have saved data across a wide variety of processor state indicators. A machine learning model, such as a neural network, convolutional neural network, etc. can be used to parse a large amount of data, look for patterns, and compare to typical patterns associated with malicious code. The patterns can be based on data from a single performance counter or a plurality of performance counters. The comparing can include any number of events that were counted by the performance counter and saved as part (or all) of the program state.

The flow 200 includes creating a known code profile 260. In embodiments, the known code profile is based on non-malicious code. One or more known “good” code profiles can be generated by gathering data based on a plurality of performance counters when the processor is known to be running “safe” (e.g., non-malicious) code. This can be performed in a testing environment, with a system that has been screened for malicious code, and so on. In embodiments, the known code profile is based on malicious code. One or more known “malicious” code profiles can be generated by gathering data based on a plurality of performance counters when the processor is known to be running malicious code. This can be accomplished in a controlled environment (e.g., in a lab), on a user's system, within a network, in a production environment, and so on. Known code profiles can be created for combinations of one or more programs or processes running in parallel to match a real world operating environment. The malicious code profile can include both malicious code and non-malicious code. Since an infected system can run both malicious and non-malicious code, including both in the known code profile, this can provide additional insight as to whether malicious code is running on the system. A known code profile can be created for a plurality of programs and/or processes. Known good and/or malicious code profiles can be assembled with the information from the performance counters such that a typical number of processor events can be associated with one or more programs, processes, etc. that can run on the processor core. Once data is collected, the known code profiles can be uploaded to a repository, a cloud server, etc. for future evaluations.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

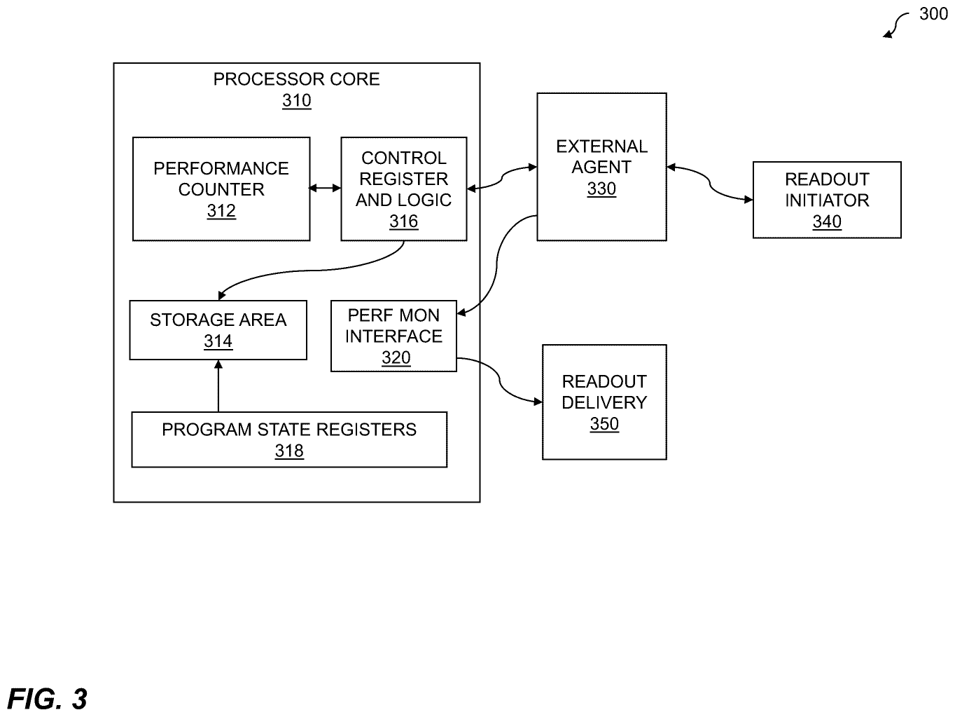

FIG. 3 is a block diagram for code profiling. Discussed above and throughout, an EPA can be used to monitor one or more program states, to generate a code profile based on one or more program states, and so on. The program states can be associated with a particular code running on a processor such as a processor core. The code profiling can be used to gauge computational resource allocation and usage. The allocation and usage can be used to identify a malicious program executing on the processor core. The code profile can be generated based on repeated saving of program states read while code is executing. The code profile can be generated by an EPA.

The block diagram 300 includes a processor core 310. The processor core can include a processor core within a plurality of processor cores. The processor core can be included on an SoC. The processor core can comprise one or more integrated circuits or chips, a processor core within one or more programmable or configurable integrated circuits such as FPGAs or ASICs, etc. In embodiments, the processor core can include a RISC-V™ processor core. The processor can include various components that augment the operation of the processor core. In the system block diagram, the processor core includes a performance counter 312, a performance counter storage area 314, and a performance counter control register 316. In embodiments, the performance counter comprises an activity counter. An activity counter can count specific activity on the processor core which is reflective of the load on the processor at any moment in time. Thus, in embodiments, the activity counter identifies load changes within the processor core. The load changes can be identified and used to alert a user, system operator, etc., that malicious code may be running on the processor core. The load changes can be saved and compared to a known profile of a “good” (e.g., non-malicious) program state or to a known profile associated with malicious code. The comparison can indicate whether malicious code is running on the processor core.

The performance counter and the performance counter control register can be configured by an external agent, such as an EPA (discussed below). The configuring can be based on an offset value. The code that is running can include an operating system, an application, malicious code, and so on. A processor core event can cause the processor to update the performance counter. In embodiments, the processor core event comprises a page fault. The processor core event can include a memory access, a branch misprediction, an interrupt, an execution exception, a cache miss, completion of an instruction, dispatch of an instruction, and so on. A performance counter event can enable saving a program state to the storage area 314. A performance counter event can include setting, resetting, incrementing, decrementing, etc. the counter. The performance counter event can further include a counter overflow. The performance counter event can include a counter underflow. In embodiments, the updating comprises incrementing, by the processor core, the performance counter, wherein the performance counter event is an overflow, and wherein the offset value comprises a distance from a performance counter overflow value. For example, if it is desired for the overflow to occur after 100 page faults, the offset value can be calculated as [(performance counter maximum value)−100]. In other embodiments, the updating comprises decrementing, by the processor core, the performance counter, wherein the performance counter event is an underflow, and wherein the offset value comprises a distance from a performance counter underflow value. For example, if it is desired for the underflow to occur after 100 page faults, the offset value can be calculated as [(performance counter minimum value)+100]. Once the performance counter event occurs and the program state is saved to the storage area 314, the EPA can reset the performance counter. If the performance counter event is an underflow, the performance counter can be reset to the minimum value plus the offset. If the performance counter event is an overflow, the performance counter can be reset to the maximum value less the offset. Thus, embodiments include resetting, by the EPA, the performance counter.

In embodiments, the configuring, the updating, the saving, and the resetting are periodically repeated. The periodically repeating of the above steps can enable generation of a code profile for code executing in the processor core. The program state that is saved can be read from one or more program state registers 318. The program state registers can include one or more of an application program status register (APSR), an arithmetic logic unit (ALU) flag, an interrupt program status register (IPSU), an execution program status register (EPSU), and the like. In embodiments, the program state can include a current program counter state. The processor core can further include a performance monitor interface 320. The performance monitor interface can provide an interface between the processor core and the EPA (described below) and the processor core and a readout delivery component 350 (discussed below).

The block diagram 300 includes an external profiling agent (EPA) 330. One or more agents can operate independently of the processor core, thereby freeing the processor core to perform its code execution tasks. The performance profiles generated by the EPA can more accurately reflect the code execution profile. A software agent such as an EPA can perform a variety of tasks, such as monitoring and profiling tasks. An external profiling agent can monitor the executing of code, and the processor state as the code is executing on the processor. The external profiling agent can monitor one or more program states, generate a performance profile from the program states, and so on. The EPA, which can include a profiling agent, can configure the performance counter 312. In embodiments, the configuring includes a performance counter control register 316. The performance counter, the performance counter storage area, and the performance counter control register can be assigned to the EPA. Additional performance counters, storage areas, and control registers can further be assigned to the same EPA or another EPA. In embodiments, the performance counter control register includes settings for the processor core event, whether profiling is enabled, and what a sampling period comprises. The sampling period can control when the processor core checks for a processor event, when the processor checks for a performance counter event, when the performance counter is reset, how often the program state is saved, and so on.

As described above, a program state can be saved to the storage area, based on a performance counter event in the performance counter. The saving can also be based on an enable bit in the performance counter control register 316 being set. The program state that is saved corresponds to code being executed on the processor core. The block diagram 300 includes a readout initiator 340. The readout initiator can indicate that a code profile readout should be initiated by the EPA 330. A readout can be initiated by a variety of events or programmed states, such as by an elapsed amount of real time, by completion of benchmark code running on the processor, by a system interrupt, and so on. The block diagram 300 includes a readout delivery element 350. The readout delivery element can deliver the code profile to a networked storage area or other suitable delivery channels. The networked storage area can include a system memory, a shared memory, cloud-based storage, etc.

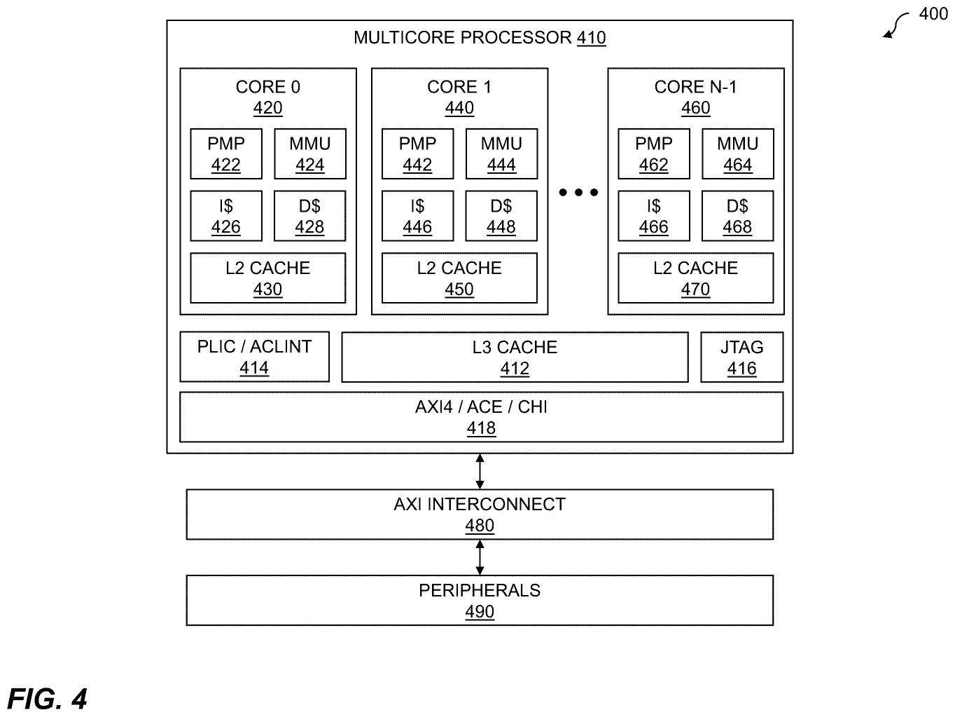

FIG. 4 is a block diagram illustrating a multicore processor. The processor can include a multi-core processor, where two or more processor cores can be included. The processor, such as a RISC-V™ processor, can include a variety of elements. The elements can include processor cores, one or more caches, memory protection and management units, local storage, and so on. The elements of the multicore processor can further include one or more of a private cache, a test interface such as a joint test action group (JTAG) test interface, one or more interfaces to a network such as a network-on-chip, shared memory, peripherals, and the like. The multicore processor is enabled by processor performance profiling using agents. A processor core is accessed, wherein the processor core includes a performance counter, a performance counter storage area, and a performance counter control register, and wherein the processor core includes a performance monitoring interface. The performance counter, the performance counter storage area, and the performance counter control register are assigned to an external profiling agent. The performance counter and the performance counter control register are loaded by the external profiling agent. A program state is saved to the storage area, based on a counter event in the performance counter and an enable bit in the performance counter control register being set, wherein the program state that is saved corresponds to code being executed on the processor core. The program state is read, from the storage area, by the external profiling agent.

The block diagram 400 includes a multicore processor 410. The multicore processor can comprise two or more processors, where the two or more processors can include homogeneous processors, heterogeneous processors, etc. In the block diagram, the multicore processor can include N processor cores such as core 0 420, core 1 440, core N-1 460, and so on. Each processor can comprise one or more elements. In embodiments, each core, including cores 0 through core N-1, can include a physical memory protection (PMP) element, such as PMP 422 for core 0; PMP 442 for core 1, and PMP 462 for core N-1. In a processor architecture such as the RISC-V™ architecture, PMP can enable processor firmware to specify one or more regions of physical memory such as cache memory of the shared memory, and to control permissions to access the regions of physical memory. The cores can include a memory management unit (MMU) such as MMU 424 for core 0, MMU 444 for core 1, and MMU 464 for core N-1. The memory management units can translate virtual addresses used by software running on the cores to physical memory addresses with caches, the shared memory system, etc.

The processor cores associated with the multicore processor 410 can include caches such as instruction caches and data caches. The caches, which can comprise level 1 (L1) caches, can include an amount of storage such as 16KB, 32KB, and so on. The caches can include an instruction cache I$ 426 and a data cache D$ 428 associated with core 0; an instruction cache I$ 446 and a data cache D$ 448 associated with core 1; and an instruction cache I$ 466 and a data cache D$ 468 associated with core N-1. In addition to the level 1instruction and data caches, each core can include a level 2 (L2) cache. The level 2 caches can include an L2 cache 430 associated with core 0; an L2 cache 450 associated with core 1; and an L2 cache 470 associated with core N-1. The cores associated with the multicore processor 410 can include further components or elements. The further elements can include a level 3 (L3) cache 412. The level 3 cache, which can be larger than the level 1 instruction and data caches, and the level 2 caches associated with each core, can be shared among all of the cores. The further elements can be shared among the cores. In embodiments, the further elements can include a platform level interrupt controller (PLIC) 414. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 416. The JTAG can provide boundaries within the cores of the multicore processor. The JTAG can enable fault information to a high precision. The high-precision fault information can be critical to rapid fault detection and repair.

The multicore processor 410 can include one or more interface elements 418. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 300, the interface elements can be coupled to an interconnect. The interconnect can include a bus, a network, and so on. The interconnect can include an AXI™ interconnect 480. In embodiments, the network can include network-on-chip functionality. The AXI™ interconnect can be used to connect memory-mapped “master” or boss devices to one or more “slave” or worker devices. In the block diagram 400, the AXI interconnect 480 can provide connectivity between the multicore processor 410 and one or more peripherals 490. The one or more peripherals can include storage devices, networking devices, and so on. The peripherals can enable communication using the AXI™ interconnect by supporting standards such as AMBA™ version 4, among other standards.

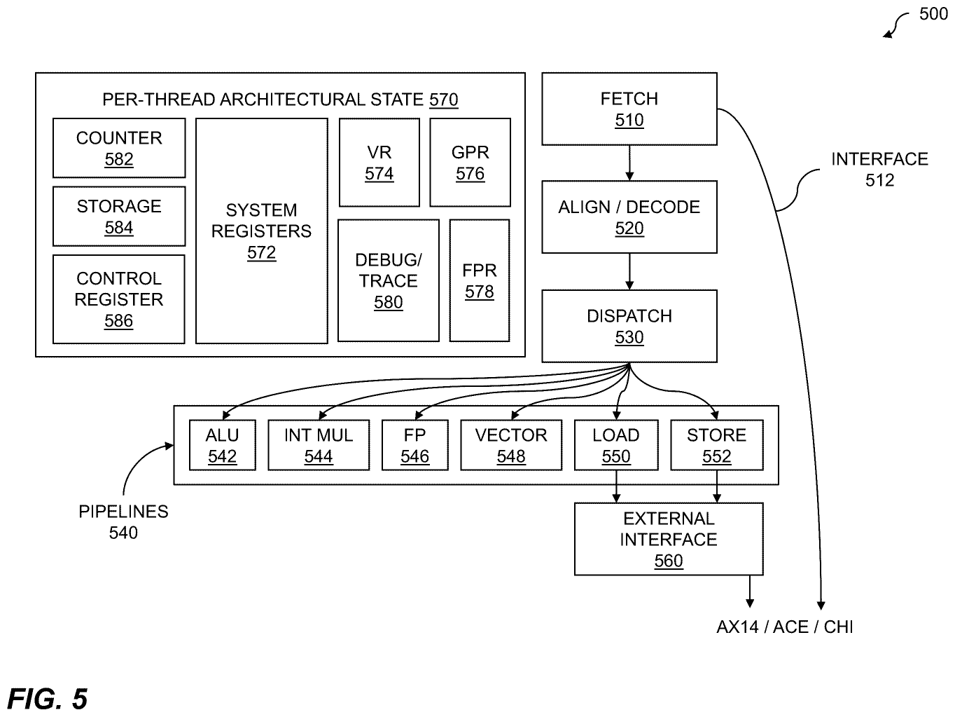

FIG. 5 is a block diagram for a pipeline. The use of one or more pipelines associated with a processor architecture can greatly enhance processing throughput. The processing throughput can be increased because multiple operations can be executed in parallel. The use of one or more pipelines supports processor performance profiling using agents. A processor core is accessed, wherein the processor core includes a performance counter, a performance counter storage area, and a performance counter control register, and wherein the processor core includes a performance monitoring interface. The performance counter, the performance counter storage area, and the performance counter control register are assigned to an external profiling agent. The performance counter and the performance counter control register are loaded by the external profiling agent. A program state is saved to the storage area, based on a counter event in the performance counter and an enable bit in the performance counter control register being set, wherein the program state that is saved corresponds to code being executed on the processor core. The program state is read, from the storage area, by the external profiling agent.

The block diagram 500 shows a block diagram of a pipeline such as a core pipeline. The blocks within the block diagram can be configurable in order to provide varying processing levels. The varying processing levels can be based on processing speed, bit lengths, and so on. The block diagram 500 can include a fetch block 510. The fetch block can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 512. The interface can include a standard interface such as one or more industry standard interfaces. The interfaces can include an Advanced extensible Interface (AXI™), an ARM™ Advanced extensible Interface (AXI™) Coherence Extensions (ACE™) interface, an Advanced Microcontroller Bus Architecture (AMBA™) Coherence Hub Interface (CHI™), etc.

The block diagram 500 includes an align and decode block 520. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The system block diagram 500 can include a dispatch block 530. The dispatch block can receive decoded instruction packets from the align and decode block. The decoded instruction packets can be used to control a pipeline 540, where the pipeline can include an in-order pipeline, an out-of-order (OoO) pipeline, etc. For the case of an in-order pipeline, the dispatch block can maintain a register “scoreboard” and can forward instruction packets to various processors for execution. For the case of an out-of-order pipeline, the dispatch block can perform additional operations from the instruction set. Instructions can be issued by the dispatch block to one or more execution units. A pipeline can be associated with the one or more execution units. The pipelines associated with the execution units can include processor cores, arithmetic logic unit (ALU) pipelines 542, integer multiplier pipelines 544, floating-point unit (FPU) pipelines 546, vector unit (VU) pipelines 548, and so on. The dispatch unit can further dispatch instructions to pipes that can include load pipelines 550, and store pipelines 552. The load pipelines and the store pipelines can access storage such as the common memory using an external interface 560. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, one or more processor cores can be configured to support multi-threading. The system block diagram can include a per-thread architectural state block 570. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 572. The system registers can be associated with individual processors or processor cores, a system comprising multiple processors or processor cores, and so on. The system registers can include exception and interrupt components, counters, etc. The per-thread architectural state can include further registers such as vector registers (VR) 574, general purpose registers (GPR) 576, and floating-point registers (FPR) 578. These registers can be used for vector operations, general purpose (e.g., integer) operations, and floating-point operations, respectively. The per-thread architectural state can include a debug and trace block 580. The debug and trace block can enable debug and trace operations to support code development, troubleshooting, and so on. In embodiments, an external debugger can communicate with a processor through a debugging interface such as a joint test action group (JTAG) interface. The per-thread architectural state can include a performance counter 582. The performance counter can be used to sample program or code execution, to generate a performance profile, and so on. The performance profile can be based on saving repeated program states. The program states can be sampled on a periodic basis and saved for analysis. In embodiments, the performance profile can be generated by the external profiling agent. The per-thread architecture can include a performance counter storage area 584. The program states, which can be sampled on a periodic basis, can be saved to the storage area, etc. The saving can be based on a counter event in the performance counter. The per-thread architecture can include a performance counter control register 586. In embodiments, the performance counter and the performance counter control register are loaded by the external profiling agent. The loading of the performance counter and the performance counter control register can be based on a particular event. The particular event can be associated with the processor core and can include a counter event, an interrupt or exception, and so on. In embodiments, the particular event can include human direction such as requesting a program profile for a program or code that is executing, analyzing an anomalous event, etc.

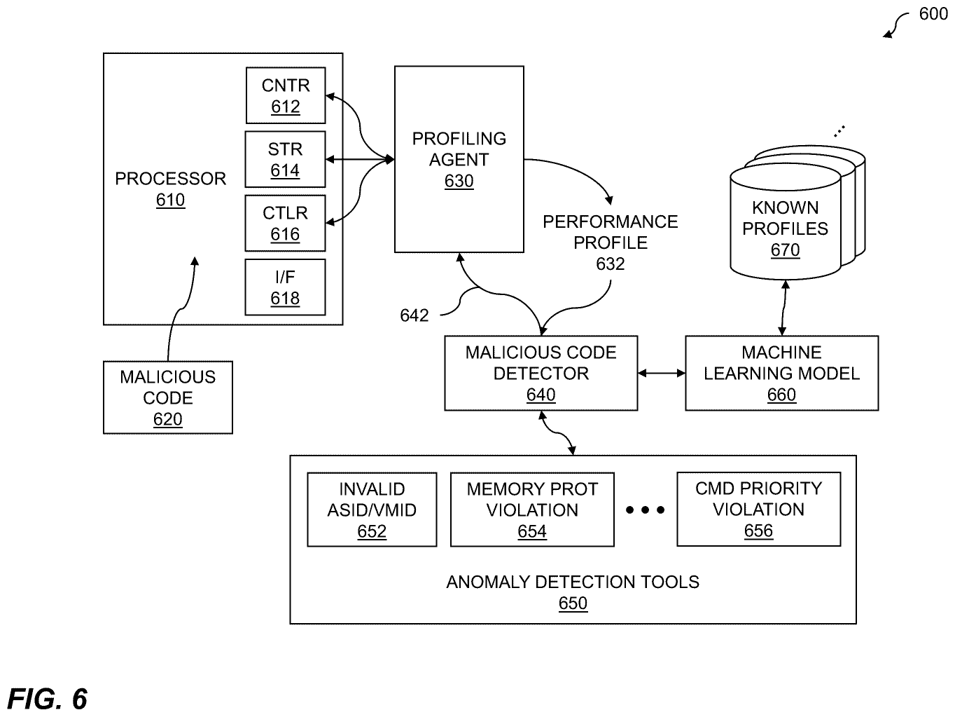

FIG. 6 is an example illustrating malicious code detection. In addition to generating profiles for programs that are authorized to be executed on a given processor core, nefarious individuals may attempt to load and execute malicious code on the processor. The malicious code can attempt to steal confidential information, to perpetrate extortion by encrypting critical data, to disrupt operations of critical infrastructure, and so on. Since the malicious code can present a performance profile anomaly compared to performance profiles of authorized code, in embodiments, the malicious code can be detected. The malicious code detection is enabled by external performance agents (EPAs).

Malicious code detection 600 can include a processor 610. The processor can include standalone processors within integrated circuits or chips, processor cores such as cores in FPGAs or ASICs, and so on. In embodiments, the processor can be based on a processor architecture such as a RISC-V™ architecture. The processor architecture can include a multi-core processor architecture. The processor can execute an operating system, one or more program codes, and the like. The processor can include one or more elements such as one or more of an arithmetic logic unit (ALU), a memory management unit (MMU), one or more levels of cache memory, and so on. In embodiments, the processor can include a performance counter 612. Any number of performance counters can be included on the processor core. The performance counters can be associated with various tasks and/or states within the processor such as memory accesses, page faults, usage of counters, and so on. Any performance counter can be associated with any state within the core.

The performance counter can be used to sample execution of a program, code, etc. The performance counter can be controlled by an EPA 630. In embodiments, the processor can include a performance counter storage area 614. The performance counter storage area can be used to store one or more program states associated with execution of a program, performance data, etc. In embodiments, the processor can include a performance counter control register 616. The performance counter control register can include one or more fields. The fields associated with the performance counter control register can include an event designation, “enable/disable profiling,” a sampling period, etc. In further embodiments, the processor can include one or more interfaces 618. The interfaces can include one or more industry standard interfaces, interfaces specific to the processor, and the like. In embodiments, the interfaces can include an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. The interfaces can enable connection between the processor and an interconnect. The interconnect can enable the multicore processor to access a variety of peripherals such as storage elements, communications elements, etc.

Malicious code 620 can be introduced into the processor using various techniques. The malicious code is introduced with the intention to disrupt, damage, or destroy operations performed by the processor. The malicious code can be used to inflict financial damage, to extort payment, etc. The malicious code can include code for fileless malware, trojans, spyware, lockers, adware, rootkits, worms, bots, keyloggers, wiper malware, mobile malware, and the like. Because of the financial, operational, and at times physical damage that can be caused by the malicious code, it is imperative to detect the presence of malicious code as early and as quickly as possible. To assist with malicious code detection, an EPA 630 can be used. The profiling agent can further be used to counteract the effects of the malicious code. Described previously and throughout, the performance counter 612 can be configured by the EPA. The configuring can include the performance counter storage area 614, and the performance counter control register 616. In embodiments, the performance counter control register includes settings for the processor core event, whether profiling is enabled, and what a sampling period comprises. The sampling period can control when the processor core checks for a processor event, when the processor checks for a performance counter event, when the performance counter is reset, how often the program state is saved, and so on.

The external profiling agent can increase, decrease, or leave unchanged the sampling rate. The external profiling agent can be used to access state information such as state information associated with the particular code. The program state can be saved to the storage area 614. The program state can be sampled periodically, and the state samples can be stored in the storage area. The storing can be based on a performance counter event such as a counter increment, a counter decrement, a counter overflow, a counter underflow, etc. The program states can be read from the storage area by the EPA. The saved program states can be analyzed to determine computational resource allocation and usage, processing duration, and so on. Embodiments further include generating a performance profile 632, based on the saving of repeated program states. The profile can indicate resource allocation, usage, etc., and the profile can be associated with a particular code. The profile can serve as an identifier for the code based on a substantially consistent profile associated with each execution of the particular code. If the generated profile is different from the “typical” profile, then this can indicate the presence of malicious code.

The performance profile 632 can be analyzed by a malicious code detector 640. The malicious code detector can analyze the performance profile provided by the external profile agent to determine whether the current code performance profile substantially matches profiles generated when the particular code was previously executed. The performance profile can vary based on tasks performed by an operating system, the mix of codes executed by the processor core at a given time, and so on. The performance profile can also differ due to corruption of the particular code, introduction of malicious code into the particular code, spoofing of the particular code by malicious code presenting itself as the particular code, etc. The performance profile can include an anomalous performance profile. The malicious code detector can use a variety of techniques and tools to detect malicious code. The malicious code detector can apply one or more techniques or tools to a performance profile and can provide an indication 642 to the profile agent. The profile agent can use the provided indication to collect additional program state data, to act against a suspected malicious code, etc.

In embodiments, the malicious code detector can access one or more anomaly detection tools 650. The anomaly detection tools can be based on verified codes such as checksums, identifiers, tags, and so on. In embodiments, the program state can include program execution identification values. In embodiments, the execution identification values include an address space identifier (ASID). In other embodiments, the execution identification values include a virtual machine identifier (VMID). The identification values can include values associated with program size, data access patterns, processor core utilization, etc. The anomaly detection tools can include an invalid ASID/VMID tool 652 to analyze the identification values. An invalid ASID/VMID tool can be used to compare program execution identification values to known values and can flag the values as invalid if the values differ. The difference in values can include values within a tolerance. In embodiments, the anomaly detection tools can include a memory protection violation tool 654. The memory protection violation tool can indicate that one or more memory accesses which violate memory protection rules were attempted. The anomaly detection tools can include a command priority violation tool 656. The command priority violation tool can indicate that execution of a command was attempted by a user or a program with insufficient privileges to execute the command.

The malicious code detector can access a machine learning model 660 such as a neural network, convolutional neural network, transformer, etc. One or more profiling agents can generate large sums of data as they collect information pertaining to the processor state. Further, the data collected can be intermixed between “good” code and “malicious” code since more than one application can execute on the processor. Machine learning can be used to find patterns in the profile that was collected, such as memory access patterns, system call patterns, etc. These patterns can be used to detect malicious code. The machine learning model can be used to compare the profile that was collected to one or more known profiles 670. A code profile that is substantially similar to that of a known “good” code profile (e.g., a code profile without malicious code), can indicate that malicious code is not present in the system, processor, cache, etc. The known profile can be provided by the user, obtained from a repository, etc. A code profile that is substantially similar (or with portions that are substantially similar) to that of code running with a malicious program can indicate that malicious software has infected the system, processor, cache, etc.

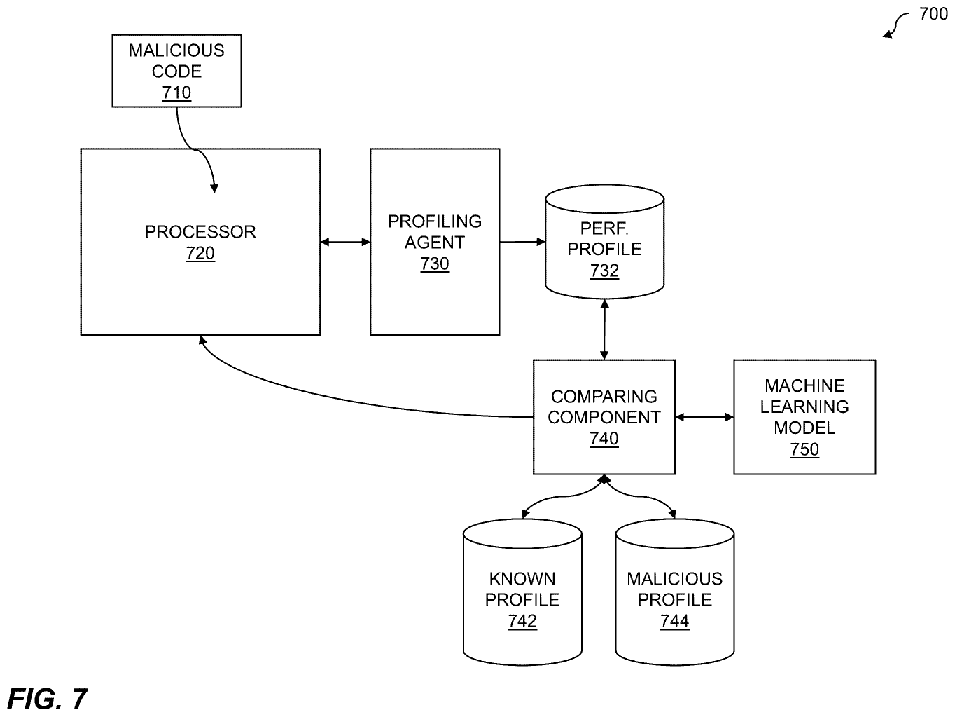

FIG. 7 is an example 700 of comparing profiles. As described previously, malicious code 710 can be introduced in a processor core 720. This code can continue undetected without the aid of an external profiling agent (EPA) 730. As discussed previously, the EPA can configure a performance counter. The processor core can update the performance counter when it encounters a processor core event. In embodiments, the processor core event comprises a page fault. A program state can be saved to a performance counter storage area, based on a performance counter event. The performance counter event can comprise an underflow of the performance counter, an overflow of the performance counter, and so on. The program state can be read from the performance storage area by the EPA. The performance counter can then be reset. In embodiments, the configuring, the updating, the saving, and the resetting are periodically repeated. The periodically repeating can be based on a sampling period. In embodiments, a performance counter control register includes settings for the processor core event, whether profiling is enabled, and what a sampling period comprises. In further embodiments, the EPA generates a code profile 732, based on the updating, the saving, the reading, and the resetting. The code profile 732 can be created from multiple program states that we saved through time to the performance counter storage area.

As discussed above and throughout, the EPA can interpret the program states that were saved to identify malicious code running on the processor core. The code profile can be compared 740 to a saved, known profile 742 of the code that is running on the processor core 720. Thus, in embodiments, the interpreting comprises comparing the code profile to a known profile of code being executed on the processor core. The saved profile may not exactly match the profile that was saved due to interrupts, exceptions, other code running on the processor core, and so on. To aid the comparing, in embodiments, the comparing includes machine learning 750. In further embodiments, the interpreting comprises comparing the code profile to a known profile of one or more malicious programs 744. The machine learning can be based on a machine learning model which can be trained with profiles from one or more programs that run on the processor core. The machine learning can be trained on a code profile that includes malicious code. The machine learning model can be based on a convolutional neural network. The convolutional neural network can execute on a processor core within the SoC, an embedded processor on the SoC, or some other processing element inside or outside the SoC.

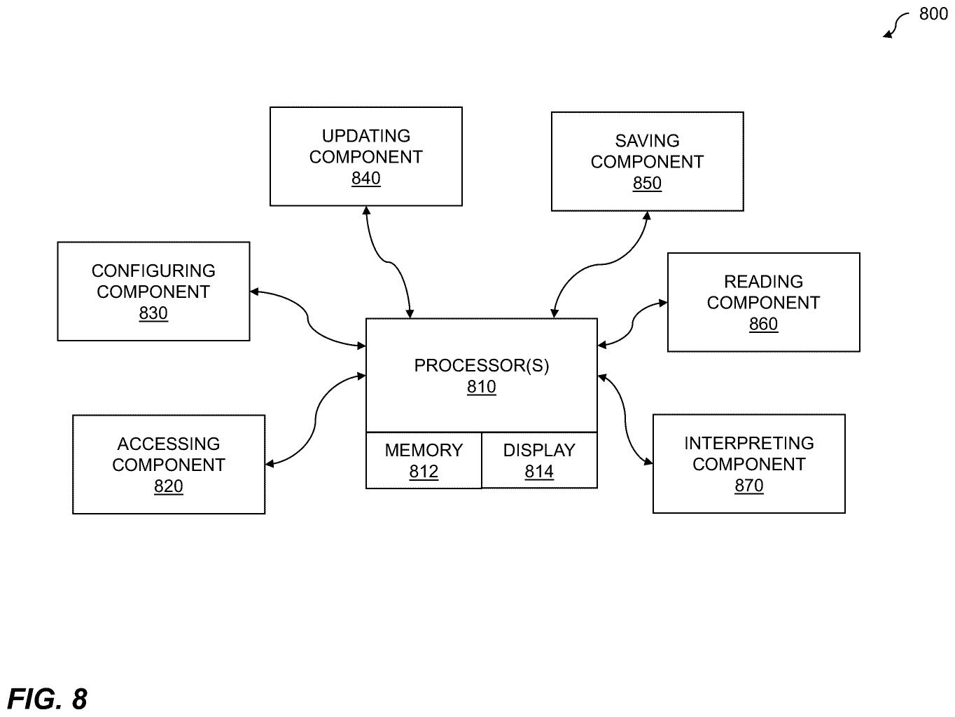

FIG. 8 is a system diagram for malicious code detection based on code profiles generated by an external profiling agent. The malicious code detection is enabled based on code profiles generated by external agents. The system can include one or more of processors, memories, cache memories, displays, counters, and so on. The system 800 can include one or more processors 810. The processors can include standalone processors within integrated circuits or chips, processor cores such as cores in FPGAs or ASICs, and so on. The one or more processors can include one or more processors within a system-on-a-chip (SoC). The one or more processors 810 are coupled to a memory 812, which stores instructions. The memory can include one or more of local memory, cache memory, system memory, etc. The system 800 can further include a display 814 coupled to the one or more processors 810. The display 814 can be used for displaying data, instructions, operations, program states, and the like. The operations can include processor performance profiling operations, where the processor performance operations can enable reading a program state by an external profiling agent. In embodiments, one or more processors 810 are coupled to the memory 812, wherein the one or more processors, when executing the instructions which are stored, are configured to: access a system-on-a-chip (SoC), wherein the SoC includes one or more processor cores, wherein each processor core within the one or more processor cores is coupled to one or more external profiling agents (EPAs) on the SoC; configure, by an EPA within the one or more EPAs, a performance counter in a processor core within the one or more processor cores, wherein the configuring is based on an offset value; update, by the processor core, the performance counter that was configured, wherein the updating is based on a processor core event; save a program state to a performance counter storage area, wherein the saving is based on a performance counter event, wherein the program state that is saved corresponds to code being executed on the processor core; read the program state, from the performance counter storage area, by the EPA; and interpret, by the EPA, the program state that was read, wherein the interpreting identifies a malicious program running on the processor core.

The system 800 can include an accessing component 820. The accessing component 820 can include functions and instructions for accessing a system-on-a-chip (SoC), wherein the SoC includes one or more processor cores, wherein each processor core within the one or more processor cores is coupled to one or more external profiling agents (EPAs) on the SoC. The profiling agents can interpret a program state to identify a malicious program running on the processor core. The processor can include various components that supplement the operation of the processor core. The processor core includes a performance counter, a performance counter storage area, and a performance counter control register. The performance counter, the performance counter storage area, and the performance counter control register can enable the processor to read a program state that was saved based on a performance counter event such as a counter overflow or a counter underflow. The counter, counter storage area, and counter control register further enable the processor core to generate profiles associated with the execution of the program. The processor core includes a performance monitoring interface. The performance monitoring interface can enable the processor core to interact with an external profiling agent. The performance monitoring interface enables reading of a state such as a program state by an external profiling agent. The external profiling agent can generate the performance profile associated with program execution, thereby freeing the processor core to execute operations associated with a program unimpeded by determining the program profile. Further, the external agent can perform program profiling substantially continuously. Each processor of the one or more processor cores has access to memory such as a common memory. The common memory can include on-chip memory, off-chip memory, etc.

The system 800 can include a configuring component 830. The configuring component 830 can include functions and instructions for configuring, by an EPA within the one or more EPAs, a performance counter in a processor core within the one or more processor cores, wherein the configuring is based on an offset value. The offset value can include a count, where the count can be associated with a count or tally of a number of processor events. The count can include a count up based on incrementing the offset value, or a count down based on decrementing the offset value. The events can include processor events. As a processor event such as a page fault occurs, the performance counter can be incremented. When the number of processor events equal to the offset has occurred, the performance counter can overflow. The overflow event indicates that the offset number of processor events have occurred.

The system 800 can include an updating component 840. The updating component 840 can include functions and instructions for updating, by the processor core, the performance counter that was configured, wherein the updating is based on a processor core event. The updating can include various operations associated with the performance counter, including incrementing and decrementing the counter. The increment can include a value such as 1, 2 and the like. The decrement can include a value such as −1, −2, and the like. The increment and the decrement can include substantially similar values.

The system 800 can include a saving component 850. The saving component 850 can include functions and instructions for saving a program state to a performance counter storage area, wherein the saving is based on a performance counter event, wherein the program state that is saved corresponds to code being executed on the processor core. The performance storage area can include an area of storage dedicated to storing a program state, a register file, a cache, shared storage, and so on. The performance counter event can include a counter overflow, a counter underflow, etc. The program state can include a profile associated with a code, runtime statistics, and the like. The system 800 can include a reading component 860. The reading component 860 can include functions and instructions for reading the program state, from the performance counter storage area, by the EPA. The reading the program state can include loading the program state into one or more processor cores within the SoC. The read processor state can be processed, analyzed, and so on. In embodiments, the performance counter can be reset by an EPA. The resetting can update the performance counter by a processor core.

The system 800 can include an interpreting component 870. The interpreting component 870 can include functions and instructions for interpreting, by the EPA, the program state that was read, wherein the interpreting identifies a malicious program running on the processor core. The saved program states can be interpreted to provide data, information, and so on associated with the program. Embodiments include generating a code profile, based on the updating, the saving, the reading, and the resetting. In embodiments, the interpreting can include comparing the code profile to a known profile of one or more malicious programs. In embodiments, the comparing can include machine learning.

In embodiments, the performance profile can be generated by the external profiling agent. The interpreting can be accomplished using a variety of techniques. In embodiments, the interpreting can include comparing the code profile to a known profile of one or more malicious programs. The interpreting can include comparing the performance profile to an expected profile for a “known good” version of the program as it runs on the processor core. In embodiments, the interpreting is based on machine learning. Profile anomalies, disparities, and other differences can indicate that the program running on the processor core was altered, that a malicious program was also running on the processor core, etc. The program state that was read can be compared to program states of programs known to have been altered, to previously discovered malicious code, etc. In embodiments, the interpreting can determine which malicious program was running on the processor core.

The system 800 can include a computer program product embodied in a non-transitory computer readable medium for malicious code detection, the computer program product comprising code which causes one or more processors to generate semiconductor logic for: accessing a system-on-a-chip (SoC), wherein the SoC includes one or more processor cores, wherein each processor core within the one or more processor cores is coupled to one or more external profiling agents (EPAs) on the SoC; configuring, by an EPA within the one or more EPAs, a performance counter in a processor core within the one or more processor cores, wherein the configuring is based on an offset value; updating, by the processor core, the performance counter that was configured, wherein the updating is based on a processor core event; saving a program state to a performance counter storage area, wherein the saving is based on a performance counter event, wherein the program state that is saved corresponds to code being executed on the processor core; reading the program state, from the performance counter storage area, by the EPA; and interpreting, by the EPA, the program state that was read, wherein the interpreting identifies a malicious program running on the processor core.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for malicious code detection comprising:
accessing a system-on-a-chip (SoC), wherein the SoC includes one or more processor cores, wherein each processor core within the one or more processor cores is coupled to one or more external profiling agents (EPAs) on the SoC;
configuring, by an EPA within the one or more EPAs, a performance counter in a processor core within the one or more processor cores, wherein the configuring is based on an offset value;
updating, by the processor core, the performance counter that was configured, wherein the updating is based on a processor core event;
saving a program state to a performance counter storage area, wherein the saving is based on a performance counter event, wherein the program state that is saved corresponds to code being executed on the processor core;
reading the program state, from the performance counter storage area, by the EPA; and
interpreting, by the EPA, the program state that was read, wherein the interpreting identifies a malicious program running on the processor core.

2. The method of claim 1 wherein the performance counter comprises an activity counter.

3. The method of claim 2 wherein the activity counter identifies load changes within the processor core.

4. The method of claim 3 wherein the activity counter is used to detect malicious activity.

5. The method of claim 1 wherein the processor core event comprises a page fault.

6. The method of claim 1 further comprising resetting, by the EPA, the performance counter.

7. The method of claim 6 wherein the configuring, the updating, the saving, and the resetting are periodically repeated.

8. The method of claim 7 further comprising generating a code profile, based on the updating, the saving, the reading, and the resetting.

9. The method of claim 8 wherein the interpreting comprises comparing the code profile to a known profile of code being executed on the processor core.

10. The method of claim 9 wherein the comparing includes machine learning.

11. The method of claim 8 wherein the interpreting comprises comparing the code profile to a known profile of one or more malicious programs.

12. The method of claim 1 wherein the updating comprises incrementing, by the processor core, the performance counter, wherein the performance counter event is an overflow, and wherein the offset value comprises a distance from a performance counter overflow value.

13. The method of claim 1 wherein the updating comprises decrementing, by the processor core, the performance counter, wherein the performance counter event is an underflow, and wherein the offset value comprises a distance from a performance counter underflow value.

14. The method of claim 1 wherein the interpreting is based on machine learning.

15. The method of claim 1 wherein the program state includes execution identification values.

16. The method of claim 15 wherein the execution identification values include an address space identifier (ASID).

17. The method of claim 15 wherein the execution identification values include a virtual machine identifier (VMID).

18. The method of claim 1 wherein the configuring includes a performance counter control register.

19. The method of claim 18 wherein the performance counter control register includes settings for the processor core event, whether profiling is enabled, and what a sampling period comprises.

20. The method of claim 1 further comprising creating a known code profile.

21. The method of claim 20 wherein the known code profile is based on non-malicious code.

22. The method of claim 20 wherein the known code profile is based on malicious code.

23. A computer program product embodied in a non-transitory computer readable medium for malicious code detection, the computer program product comprising code which causes one or more processors to generate semiconductor logic for:
accessing a system-on-a-chip (SoC), wherein the SoC includes one or more processor cores, wherein each processor core within the one or more processor cores is coupled to one or more external profiling agents (EPAs) on the SoC;
configuring, by an EPA within the one or more EPAs, a performance counter in a processor core within the one or more processor cores, wherein the configuring is based on an offset value;
updating, by the processor core, the performance counter that was configured, wherein the updating is based on a processor core event;
saving a program state to a performance counter storage area, wherein the saving is based on a performance counter event, wherein the program state that is saved corresponds to code being executed on the processor core;
reading the program state, from the performance counter storage area, by the EPA; and
interpreting, by the EPA, the program state that was read, wherein the interpreting identifies a malicious program running on the processor core.

24. A computer system for malicious code detection comprising:
a memory which stores instructions;
one or more processors coupled to the memory wherein the one or more processors, when executing the instructions which are stored, are configured to:
access a system-on-a-chip (SoC), wherein the SoC includes one or more processor cores, wherein each processor core within the one or more processor cores is coupled to one or more external profiling agents (EPAs) on the SoC;
configure, by an EPA within the one or more EPAs, a performance counter in a processor core within the one or more processor cores, wherein the configuring is based on an offset value;
update, by the processor core, the performance counter that was configured, wherein the updating is based on a processor core event;
save a program state to a performance counter storage area, wherein the saving is based on a performance counter event, wherein the program state that is saved corresponds to code being executed on the processor core;
read the program state, from the performance counter storage area, by the EPA; and
interpret, by the EPA, the program state that was read, wherein the interpreting identifies a malicious program running on the processor core.
